(19) United States
(12) Patent Application Publication
(10) Pub. No.: US 2021/0261132 A1
(43) Pub. Date: Aug. 26, 2021

(54) TRAVEL CONTROL APPARATUS, TRAVEL CONTROL METHOD, AND COMPUTER-READABLE STORAGE MEDIUM STORING PROGRAM

(71) Applicant: HONDA MOTOR CO., LTD., Tokyo (JP)

(72) Inventor: Keisuke OKA, Wako-shi (JP)

(21) Appl. No.: 17/172,168

(22) Filed: Feb. 10, 2021

(30) Foreign Application Priority Data
Feb. 21, 2020 (JP) 2020-028338

(51) Int. Cl. B60W 30/18; B60W 30/095; B60W 30/09; B60W 40/04; G06K 9/00

(52) U.S. Cl. CPC B60W 30/18159; B60W 30/0956; B60W 30/09; B60W 2554/4029; G06K 9/00805; G06K 9/00369; B60W 40/04

(57) ABSTRACT

A travel control apparatus that controls travel of a vehicle, comprises: a recognition unit configured to recognize external environment of the vehicle; and a travel control unit configured to control travel of the vehicle based on a result of recognition by the recognition unit. When the vehicle proceeds, at an intersection, to an intersecting traffic lane that intersects a traffic lane in which the vehicle travels, if the intersection is an intersection that satisfies a condition, the travel control unit controls the travel of the vehicle by a different travel control from a travel control for causing the vehicle to proceed through an intersection that does not satisfy the condition.

### CROSS-REFERENCE TO RELATED APPLICATION(S)

This application claims priority to and the benefit of Japanese Patent Application No. 2020-028338 filed on Feb. 21, 2020, the entire disclosure of which is incorporated herein by reference.

### BACKGROUND OF THE INVENTION

### Field of the Invention

The present invention relates to a travel control apparatus, a travel control method, and a computer-readable storage medium storing a program for controlling travel of a vehicle.

### Description of the Related Art

Japanese Patent Laid-Open No. 2015-170233 describes determining collision likelihood when a self-vehicle turns right at a crossroad with respect to both an oncoming vehicle and a pedestrian, or with respect to a plurality of oncoming vehicles and a pedestrian when there are a plurality of oncoming lanes.

### SUMMARY OF THE INVENTION

The present invention provides a travel control apparatus, a travel control method, and a computer-readable storage medium storing a program for causing a vehicle to proceed by means of control corresponding to an intersection if the intersection satisfies a condition.

The present invention in its first aspect provides a travel control apparatus that controls travel of a vehicle, the apparatus including: a recognition unit configured to recognize external environment of the vehicle; and a travel control unit configured to control travel of the vehicle based on a result of recognition by the recognition unit, wherein when the vehicle proceeds, at an intersection, to an intersecting traffic lane that intersects a traffic lane in which the vehicle travels, if the intersection is an intersection that satisfies a condition, the travel control unit controls the travel of the vehicle by a different travel control from a travel control for causing the vehicle to proceed through an intersection that does not satisfy the condition.

The present invention in its second aspect provides a travel control method executed by a travel control apparatus that controls travel of a vehicle, the method including: controlling the travel of the vehicle based on a result of recognition by a recognition unit configured to recognize external environment of the vehicle; and when the vehicle proceeds, at an intersection, to an intersecting traffic lane that intersects a traffic lane in which the vehicle travels, if the intersection is an intersection that satisfies a condition, controlling the travel of the vehicle by a different travel control from a travel control for causing the vehicle to proceed through an intersection that does not satisfy the condition.

The present invention in its third aspect provides a non-transitory computer-readable storage medium storing a program for causing a computer to: control the travel of the vehicle based on a result of recognition by a recognition unit configured to recognize external environment of the vehicle; and when the vehicle proceeds, at an intersection, to an intersecting traffic lane that intersects a traffic lane in which the vehicle travels, if the intersection is an intersection that satisfies a condition, control the travel of the vehicle by a different travel control from a travel control for causing the vehicle to proceed through an intersection that does not satisfy the condition.

According to the present invention, if an intersection satisfies a condition, a vehicle can be caused to proceed by means of control corresponding to the intersection.

### BRIEF DESCRIPTION OF THE DRAWINGS

FIG. 1 is a diagram showing a configuration of a control apparatus for a vehicle.

FIG. 2 is a diagram showing functional blocks of a control unit.

FIGS. 3A and 3B are diagrams for illustrating operations in the present embodiment.

FIG. 4 is a diagram for illustrating behavior of a self-vehicle exhibited until reaching an intersection.

FIG. 5 is a flowchart showing travel control processing of a self-vehicle performed until reaching an intersection.

FIG. 6 is a flowchart showing processing for intra-intersection travel control.

FIG. 7 is a flowchart showing processing for determining whether or not a self-vehicle can proceed.

FIG. 8 is a diagram for illustrating processing for determining whether or not the self-vehicle can proceed.

FIG. 9 is a flowchart showing processing for determining whether or not to the self-vehicle can pass.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

Japanese Patent Laid-Open No. 2015-170233 determines collision likelihood with respect to all objects with which a self-vehicle may collide when turning right. However, if the collision likelihood is uniformly determined even at an intersection in which no oncoming vehicle can be present, such as a T junction, processing efficiency will be degraded. According to one aspect of the present invention, if an intersection satisfies a condition, a vehicle can be caused to proceed by means of control corresponding to the intersection.

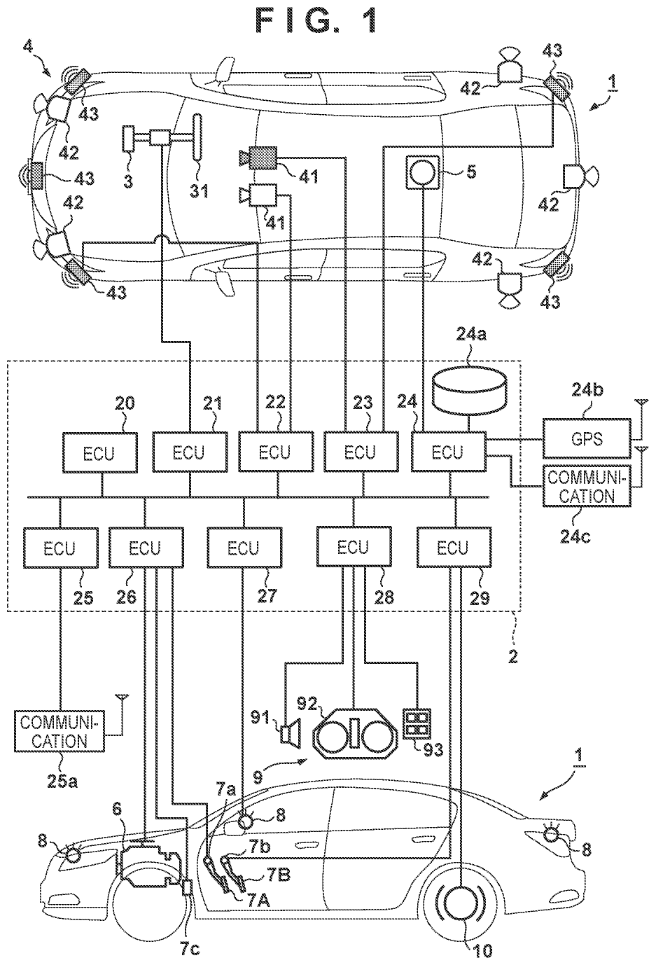

FIG. 1 is a block diagram of a control apparatus for a vehicle (travel control apparatus) according to an embodiment of the present invention, and the control apparatus controls a vehicle 1. In FIG. 1, an overview of the vehicle 1 is shown in a plan view and a side view. As an example, the vehicle 1 is a sedan type four-wheeled passenger car.

The control apparatus in FIG. 1 includes a control unit 2. The control unit 2 includes a plurality of ECUs 20 to 29, which are communicably connected to each other by an in-vehicle network. Each of the ECUs includes a processor, which is typified by a CPU, a storage device such as a semiconductor memory, an interface for an external device, and so on. The storage device stores programs to be executed by the processor, data to be used in processing by the processor, and so on. Each of the ECUs may include a plurality of processors, storage devices, interfaces, and so on. The configuration of the control apparatus in FIG. 1 may be a computer that carries out the present invention that relates to a program.

Functions or the like assigned to the respective ECUs 20 to 29 will be described below. Note that the number of ECUs and the functions assigned thereto can be designed as appropriate, and can be further segmented than in the present embodiment, or can be integrated.

The ECU 20 executes control associated with automated driving of the vehicle 1. During automated driving, at least either steering or acceleration/deceleration of the vehicle 1 is automatically controlled. In a later-described control example, both steering and acceleration/deceleration are automatically controlled.

The ECU 21 controls an electric power steering device 3. The electric power steering device 3 includes a mechanism for steering front wheels in accordance with a driver's driving operation (steering operation) to a steering wheel 31. The electric power steering device 3 includes a motor that exerts a driving force for assisting in the steering operation or automatically steering the front wheels, a sensor for detecting a steering angle, and so on. If the driving state of the vehicle 1 is automated driving, the ECU 21 automatically controls the electric power steering device 3 in response to an instruction from the ECU 20, and controls the traveling direction of the vehicle 1.

The ECUs 22 and 23 control detection units 41 to 43 for detecting the surrounding situation of the vehicle and perform information processing on the detection results. The detection units 41 are cameras (hereinafter also referred to as “cameras 41” in some cases) for capturing images of the front of the vehicle 1. In the present embodiment, the detection units 41 are attached to the vehicle interior on the inner side of the windscreen, at a front portion of the roof of the vehicle 1. Analysis of the images captured by the cameras 41 makes it possible to extract an outline of a target and extract a lane marker (white line etc.) of a traffic lane on a road.

The detection units 42 are Light Detection and Ranging (LIDARs), and detect a target around the vehicle 1 and measure the distance to the target. In the present embodiment, five detection units 42 are provided, one on each corner of the front part of the vehicle 1, one at the center of the rear part, and one on each side of the rear part. The detection units 43 are millimeter wave radars (hereinafter referred to as “radars 43” in some cases), and detect a target around the vehicle 1 and measure the distance to the target. In the present embodiment, five radars 43 are provided, one at the center of the front part of the vehicle 1, one at each corner of the front part, and one on each corner of the rear part.

The ECU 22 controls one of the cameras 41 and the detection units 42 and performs information processing on their detection results. The ECU 23 controls the other camera 41 and the radars 43 and performs information processing on their detection results. As a result of two sets of devices for detecting the surrounding situation of the vehicle being provided, the reliability of the detection results can be improved. Also, as a result of different types of detection units such as cameras and radars being provided, manifold analysis of the surrounding environment of the vehicle is enabled.

The ECU 24 controls a gyroscope sensor 5, a GPS sensor 24b, and a communication device 24c, and performs information processing on their detection results or communication results. The gyroscope sensor 5 detects rotational motion of the vehicle 1. A path of the vehicle 1 can be determined based on the results of detection by the gyroscope sensor 5, the wheel speed, or the like. The GPS sensor 24b detects the current position of the vehicle 1. The communication device 24c wirelessly communicates with a server that provides map information, traffic information, and weather information, and acquires such information. The ECU 24 can access a database 24a of map information that is built in the storage device, and the ECU 24 searches for a route from the current location to a destination. Note that a database of the aforementioned traffic information, weather information, or the like may also be built in the database 24a.

The ECU 25 includes a communication device 25a for vehicle-to-vehicle communication. The communication device 25a wirelessly communicates with other vehicles in the surrounding area and exchanges information between the vehicles.

The ECU 26 controls a power plant 6. The power plant 6 is a mechanism that outputs a driving force for rotating drive wheels of the vehicle 1, and includes, for example, an engine and a transmission. For example, the ECU 26 controls the output of the engine in response to a driving operation (acceleration pedal operation or accelerating operation) of a driver detected by an operation detection sensor 7a provided on an acceleration pedal 7A, and switches the gear ratio of the transmission based on information such as vehicle speed detected by a vehicle speed sensor 7c. If the driving state of the vehicle 1 is automated driving, the ECU 26 automatically controls the power plant 6 in response to an instruction from the ECU 20 and controls acceleration/deceleration of the vehicle 1.

The ECU 27 controls lighting devices (headlight, tail light etc.) including direction indicators 8 (blinkers). In the example in FIG. 1, the direction indicators 8 are provided at front portions, door mirrors, and rear portions of the vehicle 1.

The ECU 28 controls an input/output device 9. The input/output device 9 outputs information to the driver and accepts input of information from the driver. A sound output device 91 notifies the driver of information using a sound. A display device 92 notifies the driver of information by means of a display of an image. The display device 92 is, for example, disposed in front of the driver seat and constitutes an instrument panel or the like. Note that although an example of using a sound and a display is described here, information may alternatively be notified using a vibration and/or light. Further, information may be notified by combining two or more of a sound, a display, a vibration, and light. Furthermore, the combination may be varied or the notification mode may be varied in accordance with the level (e.g., degree of urgency) of information to be notified. The display device 92 includes a navigation device.

An input device 93 is a switch group that is disposed at a position at which it can be operated by the driver and gives instructions to the vehicle 1, and may also include a sound input device.

The ECU 29 controls brake devices 10 and a parking brake (not shown). The brake devices 10 are, for example, disc brake devices and provided on the respective wheels of the vehicle 1, and decelerate or stop the vehicle 1 by applying resistance to the rotation of the wheels. For example, the ECU 29 controls operations of the brake devices 10 in response to a driving operation (braking operation) of the driver detected by an operation detection sensor 7b provided on a brake pedal 7B. If the driving state of the vehicle 1 is automated driving, the ECU 29 automatically controls the brake devices 10 in response to an instruction from the ECU 20 and controls deceleration and stop of the vehicle 1. The brake devices 10 and the parking brake can also be operated to maintain the stopped state of the vehicle 1. If the transmission of the power plant 6 includes a parking lock mechanism, it can also be operated to maintain the stopped state of the vehicle 1.

Control Example

A description will be given of control associated with automated driving of the vehicle 1 executed by the ECU 20. If an instruction of a destination and automated driving is given by the driver, the ECU 20 automatically controls the travel of the vehicle 1 to the destination in accordance with a guided route searched for by the ECU 24. During automated control, the ECU 20 acquires information (external information) associated with the surrounding situation of the vehicle 1 from the ECUs 22 and 23, and gives instructions to the ECUs 21, 26, and 29 based on the acquired information to control steering and acceleration/deceleration of the vehicle 1.

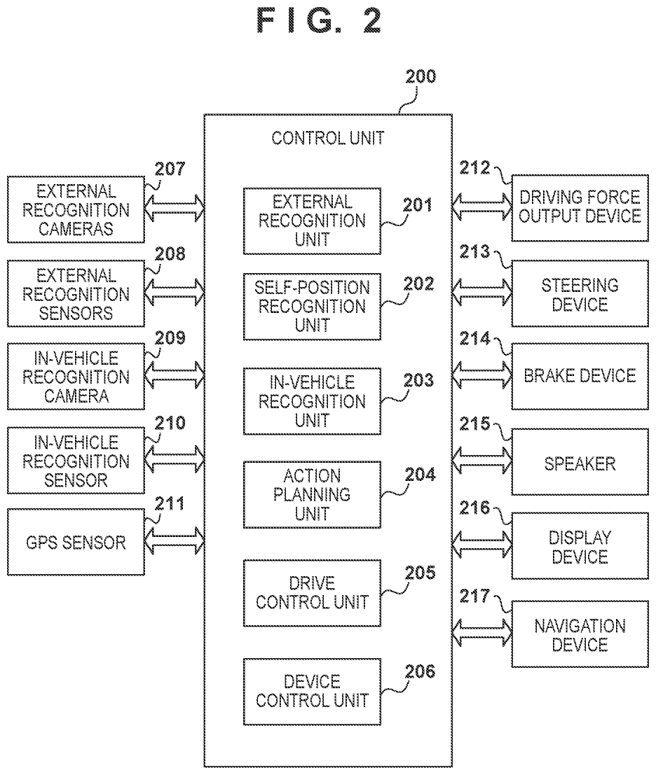

FIG. 2 is a diagram showing functional blocks of the control unit 2. A control unit 200 corresponds to the control unit 2 in FIG. 1, and includes an external recognition unit 201, a self-position recognition unit 202, an in-vehicle recognition unit 203, an action planning unit 204, a drive control unit 205, and a device control unit 206. Each block is realized by one or more of the ECUs shown in FIG. 1.

The external recognition unit 201 recognizes external information regarding the vehicle 1 based on signals from external recognition cameras 207 and external recognition sensors 208. Here, the external recognition cameras 207 are, for example, the cameras 41 in FIG. 1, and the external recognition sensors 208 are, for example, the detection units 42 and 43 in FIG. 1. The external recognition unit 201 recognizes, for example, the type of intersection, a scene of a railroad crossing, a tunnel, or the like, a free space such as a road shoulder, and behavior (speed, traveling direction) of other vehicles, based on signals from the external recognition cameras 207 and the external recognition sensors 208. The type of intersection refers to, for example, recognition that an intersection is a crossroad, a T junction, or the like. The self-position recognition unit 202 recognizes the current position of the vehicle 1 based on a signal from the GPS sensor 211. Here, the GPS sensor 211 corresponds to the GPS sensor 24b in FIG. 1, for example.

The in-vehicle recognition unit 203 identifies an occupant of the vehicle 1 and recognizes the state of the occupant based on signals from an in-vehicle recognition camera 209 and an in-vehicle recognition sensor 210. The in-vehicle recognition camera 209 is, for example, a near-infrared camera installed on the display device 92 inside the vehicle 1, and detects the direction of the line of sight of the occupant, for example. The in-vehicle recognition sensor 210 is, for example, a sensor for detecting a biological signal of the occupant. The in-vehicle recognition unit 203 recognizes that the occupant is in a dozing state or a state of doing work other than driving, based on those signals.

The action planning unit 204 plans actions of the vehicle 1, such as an optimal path and a risk-avoiding path, based on the results of recognition by the external recognition unit 201 and the self-position recognition unit 202. The action planning unit 204 plans actions based on an entrance determination based on a start point and an end point of an intersection, a railroad crossing, or the like, and prediction of behavior of other vehicles, for example. The drive control unit 205 controls a driving force output device 212, a steering device 213, and a brake device 214 based on an action plan made by the action planning unit 204. Here, for example, the driving force output device 212 corresponds to the power plant 6 in FIG. 1, the steering device 213 corresponds to the electric power steering device 3 in FIG. 1, and the brake device 214 corresponds to the brake device 10.

The device control unit 206 controls devices connected to the control unit 200. For example, the device control unit 206 controls a speaker 215 to cause the speaker 215 to output a predetermined sound message, such as a message for warning or navigation. Also, for example, the device control unit 206 controls a display device 216 to cause the display device 216 to display a predetermined interface screen. The display device 216 corresponds to the display device 92, for example. Also, for example, the device control unit 206 controls a navigation device 217 to acquire setting information in the navigation device 217.

The control unit 200 may also include functional blocks other than those shown in FIG. 2 as appropriate, and may also include, for example, an optimal path calculation unit for calculating an optimal path to the destination based on the map information acquired via the communication device 24c. Also, the control unit 200 may also acquire information from anything other than the cameras and sensors shown in FIG. 2, and may acquire, for example, information regarding other vehicles via the communication device 25a. Also, the control unit 200 receives detection signals from various sensors provided in the vehicle 1, as well as the GPS sensor 211. For example, the control unit 200 receives detection signals from a door opening/closing sensor and a mechanism sensor on a door lock that are provided in a door portion of the vehicle 1, via an ECU configured in the door portion. Thus, the control unit 200 can detect unlocking of the door and a door opening/closing operation.

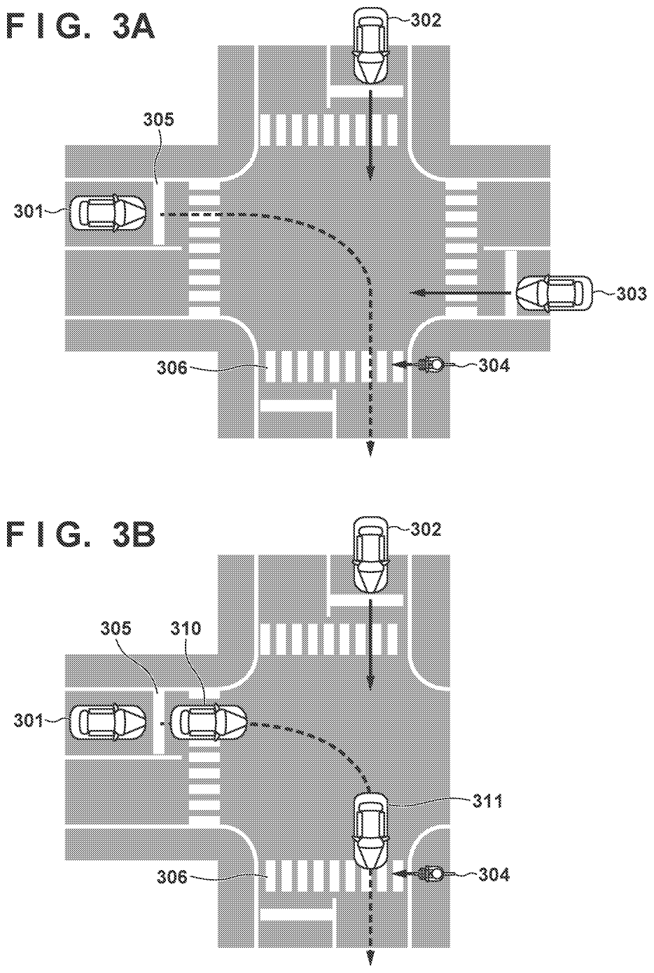

Operations in the present embodiment will be described below. FIG. 3A is a diagram showing a state where a self-vehicle 301 turns right at a crossroad through a path indicated by a broken line. At the crossroad in FIG. 3A, there are not only the self-vehicle 301 but also an intersecting vehicle 302, an oncoming vehicle 303, and a moving body 304 such as a pedestrian or a bicycle that crosses a pedestrian crossing 306. That is to say, in the case of FIG. 3A, when the self-vehicle 301 turns right, the intersecting vehicle 302, the oncoming vehicle 303, and the moving body 304 need to be considered as objects for which collision likelihood is to be determined. Although two traffic lanes are shown in FIG. 3A, the more the number of traffic lanes increases, the more the number of intersecting vehicles 302 and oncoming vehicles 303 and the number of behavior patterns increase, and the more complex the determination of collision likelihood becomes. In the case of FIG. 3A, the self-vehicle 301 determines, in a state of stopping at a stop line 305, the likelihood of collision with the intersecting vehicle 302, the oncoming vehicle 303, and the moving body 304, and starts turning right if it is determined that the self-vehicle 301 can pass.

FIG. 3B is a diagram showing a state where the self-vehicle 301 turns right at a T junction through a path indicated by a broken line. At the T junction in FIG. 3B, no oncoming vehicle 303 can be present, unlike the crossroad in FIG. 3A. That is to say, in the case of FIG. 3B, when the self-vehicle 301 turns right, the intersecting vehicle 302 and the moving body 304 need only be considered as objects for which collision likelihood is to be determined. Here, if the right-turn determination processing performed in the case of FIG. 3A is applied to the case of FIG. 3B, processing for the moving body 304 is executed although it is not necessarily be needed when entering the crossroad.

In the present embodiment, the likelihood of collision with the intersecting vehicle 302 is determined in a state where the vehicle 301 has proceeded to a position 310 beyond the stop line 305. If, as a result, it is determined that the vehicle 301 can proceed to a position 311, the vehicle 301 is caused to proceed to the position 311 and then stopped. Then, the likelihood of collision with the moving body 304 is determined at the position 311, and if it is determined that the likelihood of collision with the moving body 304 is higher than a threshold due to, for example, the moving body 304 being about to move onto the pedestrian crossing 306, it is determined that the vehicle 301 cannot pass through the pedestrian crossing 306, and the vehicle 301 is stopped until the likelihood of collision with the moving body 304 falls below the threshold. On the other hand, if the collision likelihood is lower than the threshold (e.g., if the moving body 304 is not present or is moving away from the pedestrian crossing 306), it is determined that the vehicle 301 can pass through the pedestrian crossing 306, and the vehicle 301 is controlled to pass through the pedestrian crossing 306.

Thus, in the present embodiment, in a situation where no oncoming vehicle 303 can be present, the likelihood of collision with the moving body 304 is not determined when entering the crossroad, unlike the situation where the oncoming vehicle 303 is present. Accordingly, processing can be simplified compared with the case of the crossroad in FIG. 3A. Furthermore, since proceeding determination is performed while entering the intersection, the chances to enter the intersection can be increased, and the vehicle can turn right more smoothly.

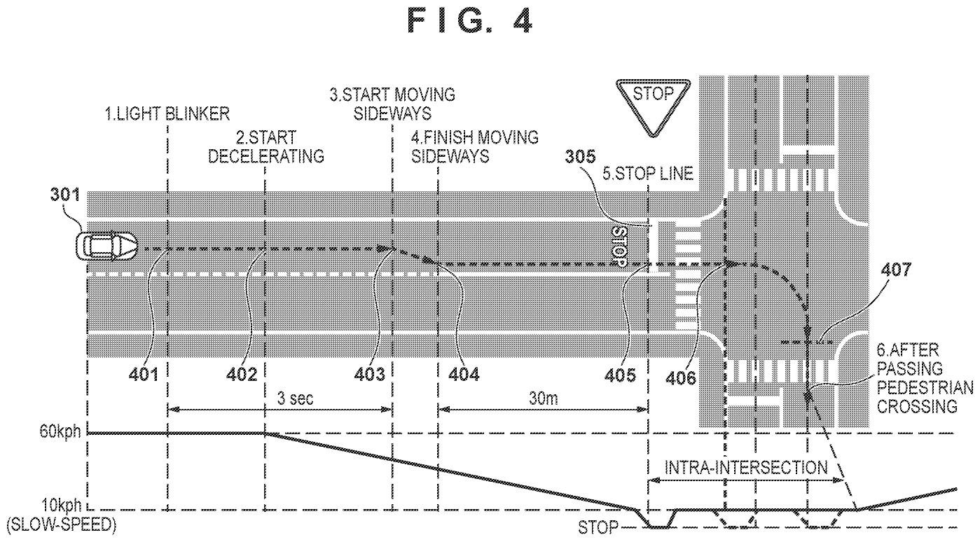

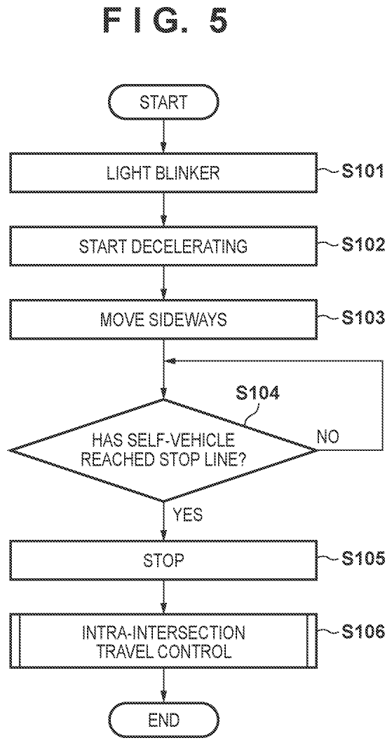

Behavior exhibited until reaching an intersection will be described with reference to FIGS. 4 and 5. FIG. 4 is a diagram for illustrating behavior of the self-vehicle 301 exhibited until reaching an intersection, and FIG. 5 is a flowchart showing travel control processing of the self-vehicle 301 performed until reaching the intersection. The processing in FIG. 5 is realized by the control unit 200, for example. The processing in FIG. 5 starts if an intersection is recognized in front of the self-vehicle 301 at a predetermined distance. At this point, the control unit 200 may recognize the type of intersection using the external recognition unit 201 based on, for example, map information and road information. The type of intersection refers to, for example, a crossroad, a T junction, or the like. It is assumed that, before starting the processing in FIG. 5, the self-vehicle 301 is traveling at 60 km/h as shown in FIG. 4.

In step S101, the control unit 200 lights a blinker for turning right. At this time, the self-vehicle 301 is traveling through a position 401 in FIG. 4. In step S102, the control unit 200 starts decelerating the self-vehicle 301, and in step S103, the control unit 200 starts moving the self-vehicle 301 sideways in the rightward direction with respect to the vehicle width. In FIG. 4, the self-vehicle 301 starts decelerating at a position 402 and starts moving sideways at a position 403. Note that the time from when lighting the blinker until when starting moving sideways, that is, the time taken to move from the position 401 to the position 403 is predetermined, and is, for example, three seconds. Upon finishing moving sideways at a position 404, the self-vehicle 301 travels while decelerating until reaching the stop line 305 (position 405).

In step S104, the control unit 200 determines whether or not the self-vehicle 301 has reached the stop line 305. If it is determined that the self-vehicle 301 has not reached the stop line 305, the processing in step S104 is repeated. If it is determined that the self-vehicle 301 has reached the stop line 305, in step S105, the control unit 200 stops the self-vehicle 301 at the stop line 305. Note that, at this point, the control unit 200 may also recognize the type of intersection based on the results of recognition by the external recognition cameras 207, for example. In the present embodiment, it is assumed that the control unit 200 recognizes a T junction as the type of intersection. In step S106, the control unit 200 performs a later-described intra-intersection travel control. The processing in FIG. 5 ends after step S106.

In the present embodiment, if an intersection such as a T junction at which no oncoming vehicle can be present is recognized, intra-intersection passage control, such as that described below, is performed. During the intra-intersection passage control, processing for a moving body that is moving on a pedestrian crossing in a right-turn or left-turn direction is not performed when entering an intersection, unlike the case of turning right at an intersection such as a crossroad in which an oncoming vehicle is present. Accordingly, processing performed when turning right can be further simplified.

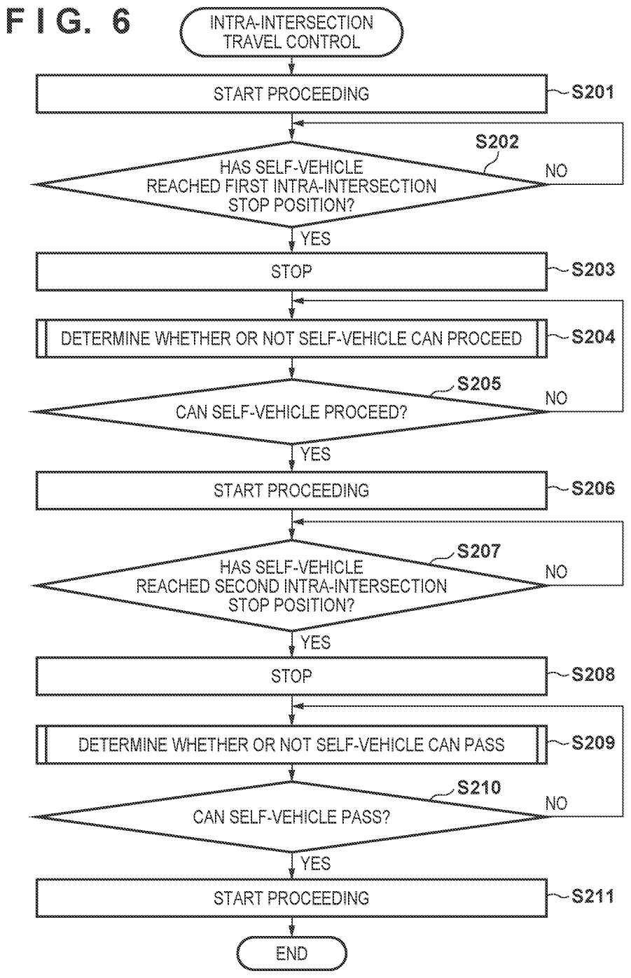

Next, behavior of passing through an intersection will be described with reference to FIGS. 4 and 6. FIG. 6 is a flowchart showing processing for the intra-intersection travel control in step S106.

In step S201, the control unit 200 causes the self-vehicle 301 to start proceeding at low speed (slow-speed start). For example, the control unit 200 causes the self-vehicle 301 to proceed at slow speed, namely at 10 km/h, as shown in FIG. 4. In step S202, the control unit 200 determines whether or not the self-vehicle 301 has reached a first intra-intersection stop position. Here, the first intra-intersection stop position corresponds to the position 310 in FIG. 3B and a position 406 in FIG. 4. Step S202 is repeated until it is determined that the self-vehicle 301 has reached the first intra-intersection stop position. If it is determined in step S202 that the self-vehicle 301 has reached the first intra-intersection stop position, in step S203, the control unit 200 stops the self-vehicle 301 at the first intra-intersection stop position. Then, in step S204, the control unit 200 performs later-described determination of whether or not the self-vehicle can travel.

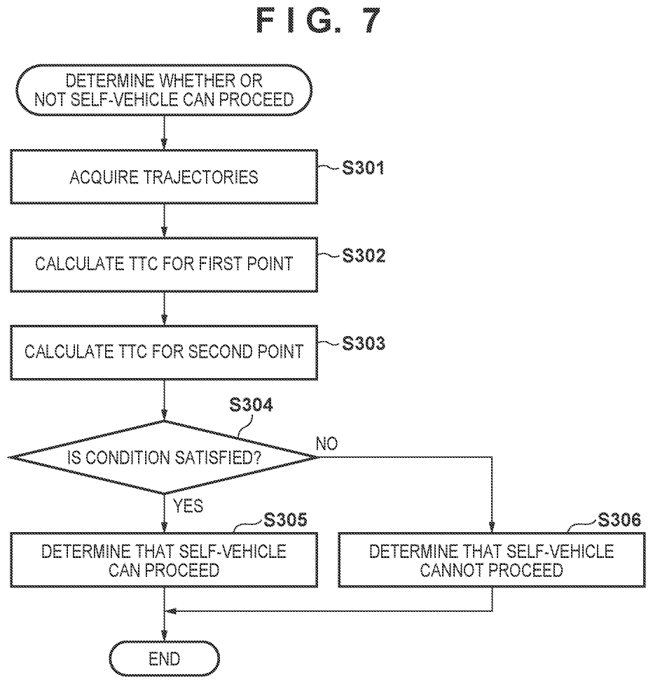

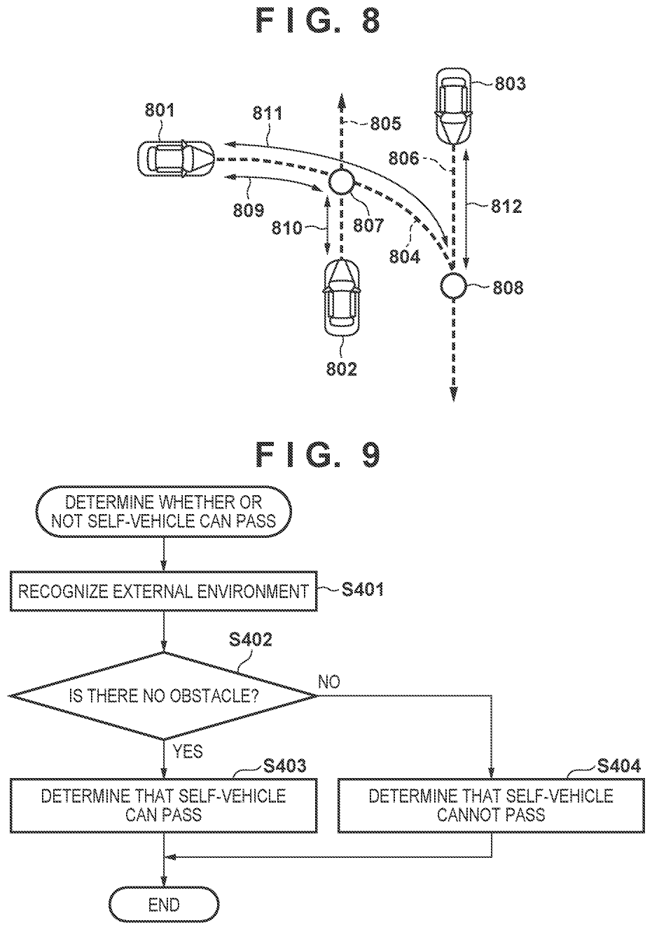

FIG. 7 is a flowchart showing processing for determining whether or not the self-vehicle can proceed in step S204. In step S301, the control unit 200 acquires travel trajectories of the self-vehicle and intersecting vehicles. FIG. 8 is a diagram for illustrating acquisition of the travel trajectories in step S301. A self-vehicle 801 in FIG. 8 corresponds to the self-vehicle 301 in FIGS. 3A and 3B, and an intersecting vehicle 803 corresponds to the intersecting vehicle 302 in FIGS. 3A and 3B. The intersecting vehicle 802 is an intersecting vehicle traveling in a direction opposite to the intersecting vehicle 803. Note that the self-vehicle 801 is located at the first intra-intersection stop position that is shown as the position 310 in FIG. 3B. A position 808 in FIG. 8 corresponds to the position 311 (later-described second intra-intersection stop position) forward of the pedestrian crossing 306 in FIG. 3B.

In step S301, first, the control unit 200 acquires a travel trajectory 804 from the first intra-intersection stop position, at which the self-vehicle 801 is currently located, to the position 808. Then, the control unit 200 acquires a travel trajectory 805 of the intersecting vehicle 802 and a travel trajectory 806 of the intersecting vehicle 803. When the travel trajectories of the intersecting vehicles are acquired, the intersecting vehicles need not actually be traveling, and for example, virtual lines at the center of traffic lanes intersecting the traffic lane in which the self-vehicle 801 is located may be acquired as travel trajectories 805 and 806.

In step S302, the control unit 200 acquires a time to collision (TTC) for a first point. Here, the first point refers to a first point 807 at which the travel trajectory 804 of the self-vehicle 801 intersects the travel trajectory 805 of the intersecting vehicle 802 in FIG. 8. That is to say, in step S302, when the self-vehicle 801 travels along the travel trajectory 804, the TTC taken until colliding with the intersecting vehicle 802 at the first point 807 is acquired. Here, a distance 809 is the distance from the first intra-intersection stop position to the first point 807 on the travel trajectory 804, and a distance 810 is the distance from the position of the intersecting vehicle 802 to the first point 807 on the travel trajectory 805. The relative speed used to obtain the TTC may be acquired from the measurement results regarding the intersecting vehicle 802 from the external recognition cameras 207 and the external recognition sensors 208 of the self-vehicle 801, with the traveling speed of the self-vehicle 801 being a predetermined speed (e.g., 10 km/h shown in FIG. 4). If the vehicle 802 is not present, the TTC may be dealt with as an infinite value.

In step S303, the control unit 200 acquires a TTC for a second point. Here, the second point refers to a second point 808 at which the travel trajectory 804 of the vehicle 801 intersects the travel trajectory 806 of the intersecting vehicle 803 in FIG. 8. That is to say, in step S303, when the self-vehicle 801 travels along the travel trajectory 804, the TTC taken until colliding with the intersecting vehicle 803 at the second point 808 is acquired. Here, a distance 811 is the distance from the first intra-intersection stop position to the second point 808 on the travel trajectory 804, and a distance 812 is the distance from the position of the intersecting vehicle 803 to the second point 808 on the travel trajectory 806. The relative speed used to obtain the TTC may be acquired from the measurement results regarding the intersecting vehicle 803 from the external recognition cameras 207 and the external recognition sensors 208 of the self-vehicle 801, with the traveling speed of the self-vehicle 801 being a predetermined speed (e.g., 10 km/h shown in FIG. 4). If the vehicle 803 is not present, the TIC may be dealt with as an infinite value.

In step S304, the control unit 200 determines whether or not the TTC calculated in step S302 (TTC1) and the TTC calculated in step S303 (TTC2) satisfy a condition. The condition is sufficient so long as the self-vehicle 301 can proceed to the second point 808. For example, it may be determined that the condition is satisfied if the TTC1 is greater than a predetermined value t1 and the TTC2 is greater than a predetermined value t2 (here, t1<t2). If it is determined in step S304 that the condition is satisfied, in step S305, the control unit 200 determines that the self-vehicle 301 can proceed to the second point 808, and ends the processing in FIG. 7. On the other hand, if it is determined in step S304 that the condition is not satisfied, in step S306, the control unit 200 determines that the self-vehicle 301 cannot proceed to the second point 808, and ends the processing in FIG. 7. Note that, in steps S305 and S306, the determination results may be stored in a storage area so as to be able to be referenced during later processing.

As described above, through the processing in FIG. 7, it can be determined whether or not the self-vehicle can proceed from the first intra-intersection stop position to the second intra-intersection stop position based on the TTC between the self-vehicle and the intersecting vehicles. Although the TTC is used in FIG. 7, any index other than the TTC may be used as long as it is an index that enables evaluation of collision risk.

FIG. 6 is referred to again. In step S205, the control unit 200 determines whether or not the result of determining whether or not the self-vehicle can proceed in step S204 is that the self-vehicle can proceed. Here, if it is determined that the self-vehicle cannot proceed, the processing in step S204 is repeated. On the other hand, if it is determined that the self-vehicle can proceed, in step S206, the control unit 200 causes the self-vehicle 301 to start proceeding at low speed (slow-speed start). For example, the control unit 200 causes the self-vehicle 301 to proceed at slow speed, namely at 10 km/h, as shown in FIG. 4. In step S207, the control unit 200 determines whether or not the self-vehicle 301 has reached the second intra-intersection stop position. Here, the second intra-intersection stop position corresponds to the position 311 in FIG. 3B and a position 407 in FIG. 4. Step S207 is repeated until it is determined that the self-vehicle 301 has reached the second intra-intersection stop position. If it is determined in step S207 that the self-vehicle 301 has reached the second intra-intersection stop position, in step S208, the control unit 200 stops the self-vehicle 301 at the second intra-intersection stop position. Then, in step S209, the control unit 200 performs later-described determination of whether or not the self-vehicle can pass.

FIG. 9 is a flowchart showing processing of the determination of whether or not the self-vehicle can pass in step S209. The scene in which the processing in FIG. 9 starts is, for example, a situation where the self-vehicle 301 is located at the position 311 in FIG. 3B. In such a situation, the intersecting vehicle 302 is a vehicle that follows the self-vehicle 301 located at the position 311.

In step S401, the control unit 200 acquires the results of recognition by the external recognition unit 201 regarding the area on and around the pedestrian crossing 306. In step S402, the control unit 200 determines whether or not there is any obstacle when the vehicle 301 is passing through the pedestrian crossing 306, based on the results of recognition by the external recognition unit 201. Here, if it is determined that there is no obstacle, in step S403, the control unit 200 determines that the self-vehicle 301 can pass through the pedestrian crossing 306, and ends the processing in FIG. 9. On the other hand, if it is recognized by the external recognition unit 201 that there is an obstacle; e.g., the moving body 304 is about to cross the pedestrian crossing 306 as shown in FIG. 3B, in step S404, the control unit 200 determines that the self-vehicle 301 cannot pass through the pedestrian crossing 306, and ends the processing in FIG. 9. As described above, whether or not the self-vehicle can pass through a pedestrian crossing can be determined through the processing in FIG. 9. Note that, in steps S403 and S404, the determination results may be stored in a storage area so as to be able to be referenced during later processing.

FIG. 6 is referred to again. In step S210, the control unit 200 determines whether or not the result of determining whether or not the self-vehicle can pass in step S209 is that the self-vehicle can pass. Here, if it is determined that the self-vehicle cannot pass, the processing in step S209 is repeated. On the other hand, if it is determined that the self-vehicle can pass, in step S211, the control unit 200 causes the self-vehicle 301 to pass through the pedestrian crossing 306. Thereafter, the processing in FIG. 6 ends.

Note that although, in FIG. 6, the self-vehicle 301 is stopped at the second intra-intersection stop position in step S208, control may alternatively be performed so as to enable the self-vehicle 301 to pass through the pedestrian crossing 306 without stopping the self-vehicle 301 at the second intra-intersection stop position. For example, after causing the self-vehicle 301 to start proceeding at low speed in step S206, the processing in S207 and the processing in steps S209 and S210 may be performed in parallel. In this case, if it is determined, before reaching the second intra-intersection stop position, that the self-vehicle 301 can pass through the pedestrian crossing 306, the vehicle 301 is controlled so as to pass through the pedestrian crossing 306 in step S211 without stopping at the second intra-intersection stop position (i.e., without performing the processing in step S208). In addition, the processing in steps S209 and S210 may be performed before step S206. That is to say, whether or not the self-vehicle 301 can pass through the pedestrian crossing 306 may be determined when the self-vehicle 301 is stopping at the first intra-intersection stop position. For example, the processing in steps S204 and S205 and the processing in steps S209 and S210 may be performed in parallel. In this case, if it is determined while the self-vehicle 301 is stopping at the first intra-intersection stop position that the self-vehicle 301 can proceed to the second intra-intersection stop position, and it is also determined that the self-vehicle 301 can pass through the pedestrian crossing 306, control may be performed so as to cause the self-vehicle 301 to proceed from the first intra-intersection stop position and pass through the pedestrian crossing 306 without stopping at the second intra-intersection stop position. Thus, in the present embodiment, stepwise determination may be performed at the first intra-intersection stop position and the second intra-intersection stop position, or it may be determined, at the first intra-intersection stop position, whether or not the self-vehicle can proceed to the second intra-intersection stop position and whether or not the self-vehicle can pass through the pedestrian crossing 306. Also, it may be determined whether or not the self-vehicle can pass through the pedestrian crossing 306, during a period after the self-vehicle has started proceeding from the first intra-intersection stop position until reaching the second intra-intersection stop position.

As described above, in the present embodiment, if an intersection such as a T junction in which no oncoming vehicle can be present is recognized, processing for the moving body 304 is not performed when entering the intersection during processing performed when turning right. Accordingly, processing can be further simplified compared with the case where processing for the moving body 304 is required when entering an intersection such as a crossroad. Furthermore, since proceeding determination is performed stepwise when proceeding through an intersection, the chances of entering the intersection can be increased, and it is possible to turn right more smoothly.

Although the present embodiment has described that the intra-intersection travel control in step S106 is performed when, for example, a T junction is recognized as the type of intersection, the intra-intersection travel control in step S106 may also be performed when a crossroad is recognized, if a situation is recognized where no oncoming vehicle can be present or is present. For example, the intra-intersection travel control in step S106 may be performed if it is recognized that the traffic lane on the oncoming vehicle 303 side in FIG. 3A is blocked. Although the present embodiment has described a configuration of travel control, other control configurations may alternatively be realized. For example, the invention may alternatively be realized as control for giving a driver a notification for proceeding through an intersection. For example, the driver may be notified of the result of performing stepwise determination at the first intra-intersection stop position and the second intra-intersection stop position, or the result of determining, at the first intra-intersection stop position, whether or not the self-vehicle can proceed to the second intra-intersection stop position and whether or not the self-vehicle can pass through the pedestrian crossing 306, or the result of determining whether or not the self-vehicle can pass through the pedestrian crossing 306, during a period after starting proceeding from the first intra-intersection stop position until reaching the second intra-intersection stop position. This configuration can realize drive assistance to improve safety when proceeding through an intersection. Although in the present embodiment a description was given for the case of turning right, the operations of the present embodiment can also be applied to the case of turning left, and the same effects as those of the present embodiment can be achieved.

### Summary of Embodiment

A travel control apparatus of the above embodiment is a travel control apparatus that controls travel of a vehicle, the apparatus including: a recognition unit (201, 207, 208) configured to recognize external environment of the vehicle; and a travel control unit (200) configured to control travel of the vehicle based on a result of recognition by the recognition unit, wherein when the vehicle proceeds, at an intersection, to an intersecting traffic lane that intersects a traffic lane in which the vehicle travels, if the intersection is an intersection (FIG. 3B) that satisfies a condition, the travel control unit controls the travel of the vehicle by a different travel control from a travel control for causing the vehicle to proceed through an intersection that does not satisfy the condition (FIG. 7, FIG. 8).

With this configuration, if the intersection satisfies the condition, a vehicle can be caused to proceed by control corresponding to this intersection.

Also, the condition is that no oncoming vehicle is present (FIG. 3B). Also, the intersection is a T junction (FIG. 3B).

With this configuration, execution of inappropriate processing can be prevented at, for example, a T junction in a situation where no oncoming vehicle can be present.

Also, if the intersection is an intersection that satisfies the condition, the travel control unit causes the vehicle to start proceeding in the intersection based on a result of determining likelihood of collision with an intersecting vehicle traveling in the intersecting traffic lane (S206 in FIG. 6).

With this configuration, the self-vehicle can be caused to proceed in the intersection if it is determined that there is no likelihood of collision with an intersecting vehicle.

Also, after causing the vehicle to start proceeding in the intersection, the travel control unit stops the vehicle in front of a pedestrian crossing on the intersecting traffic lane (S208 in FIG. 6).

With this configuration, the self-vehicle can be caused to pass through a pedestrian crossing, without determining the likelihood of collision with an oncoming vehicle, for example, if it is determined that no obstacle is present on the pedestrian crossing at an exit of the intersection.

The invention is not limited to the foregoing embodiments, and various variations/changes are possible within the spirit of the invention.

The invention is not limited to the foregoing embodiments, and various variations/changes are possible within the spirit of the invention.

What is claimed is:

1. A travel control apparatus that controls travel of a vehicle, the apparatus comprising:
a recognition unit configured to recognize external environment of the vehicle; and
a travel control unit configured to control travel of the vehicle based on a result of recognition by the recognition unit,
wherein when the vehicle proceeds, at an intersection, to an intersecting traffic lane that intersects a traffic lane in which the vehicle travels, if the intersection is an intersection that satisfies a condition, the travel control unit controls the travel of the vehicle by a different travel control from a travel control for causing the vehicle to proceed through an intersection that does not satisfy the condition.

2. The travel control apparatus according to claim 1,
wherein the condition is that no oncoming vehicle is present.

3. The travel control apparatus according to claim 1,
wherein the intersection is a T junction.

4. The travel control apparatus according to claim 1,
wherein if the intersection is an intersection that satisfies the condition, the travel control unit causes the vehicle to start proceeding in the intersection based on a result of determining likelihood of collision with an intersecting vehicle traveling in the intersecting traffic lane.

5. The travel control apparatus according to claim 4,
wherein after causing the vehicle to start proceeding in the intersection, the travel control unit stops the vehicle in front of a pedestrian crossing on the intersecting traffic lane.

6. A travel control method executed by a travel control apparatus that controls travel of a vehicle, the method comprising:
controlling the travel of the vehicle based on a result of recognition by a recognition unit configured to recognize external environment of the vehicle; and
when the vehicle proceeds, at an intersection, to an intersecting traffic lane that intersects a traffic lane in which the vehicle travels, if the intersection is an intersection that satisfies a condition, controlling the travel of the vehicle by a different travel control from a travel control for causing the vehicle to proceed through an intersection that does not satisfy the condition.

7. A non-transitory computer-readable storage medium storing a program for causing a computer to:
control travel of the vehicle based on a result of recognition by a recognition unit configured to recognize external environment of the vehicle; and
when the vehicle proceeds, at an intersection, to an intersecting traffic lane that intersects a traffic lane in which the vehicle travels, if the intersection is an intersection that satisfies a condition, control the travel of the vehicle by a different travel control from a travel control for causing the vehicle to proceed through an intersection that does not satisfy the condition.
